(19) United States
(12) Patent Application Publication
(10) Pub. No.: US 2003/0138621 A1
(43) Pub. Date: Jul. 24, 2003

(54) COMPOSITE ELEMENTS COMPRISING (I) THERMOPLASTIC POLYURETHANES AND (II) MICROCELLULAR POLYURETHANE ELASTOMERS

(76) Inventors: HEINRICH BOLLMANN, ALFHAUSEN (DE); KLAUS GIESEN, DAMME (DE); RUEDIGER KRECH, DIEPHOLZ (DE); ERHARD REICH, DAMME (DE)

Correspondence Address: BASF CORPORATION, LEGAL DEPARTMENT, 1609 BIDDLE AVENUE, WYANDOTTE, MI, 48192, US

(21) Appl. No.: 09/456,371

(22) Filed: Dec. 8, 1999

(30) Foreign Application Priority Data
Dec. 24, 1998 (DE) 19860205.7

(51) Int. Cl. B32B 3/26; B32B 3/00; B32B 5/20; B32B 27/00

(52) U.S. Cl. 428/318.6; 428/318.8; 428/315.5; 428/319.3; 428/319.7

(57) ABSTRACT

Composite elements comprise

(i) thermoplastic polyurethanes and, adhering thereto,

(ii) microcellular polyurethane elastomers with a density of from 300 to 700 kg/m³, a tensile strength to DIN 53571 of from 3 to 8 N/mm², an elongation at break to DIN 53571 of from 350 to 550%, a tear propagation resistance to DIN 53515 of from 8 to 30 N/mm and a rebound resilience to DIN 53512 of from 50 to 60%.

The invention relates to composite elements comprising

(i) thermoplastic polyurethanes, also referred to below as TPUs, and, adhering thereto,

(ii) microcellular polyurethane elastomers with a density of from 300 to 700 kg/m³, a tensile strength to DIN 53571 of from 3 to 8 N/mm², an elongation at break to DIN 53571 of from 350 to 550%, a tear propagation resistance to DIN 53515 of from 8 to 30 N/mm and a rebound resilience to DIN 53512 of from 50 to 60%.

The invention further relates to a process for producing these composite elements, and to their use.

Composite elements based on metals and rubber, also generally known as rubber-metal composites, are well known. They are widely used, for example in the running gear of road vehicles, and are described, for example, in “Fahrwerktechnik: Radaufhängungen”, 2nd edition, ed. Prof. Dipl.-Ing. Jörnsen Reimpell, Vogel Buchverlag Wurzburg, in particular on pages 77, 83, 84, 87, 281, 286 and 290. Disadvantages of these composites are the high density of their metal constituents, the relatively short service life of the rubber, and also loss of adhesion between the rigid and flexible elements of the component. It is known that this can be improved by using adhesion promoters, which are applied as liquids to the rigid elements and solidify and, where appropriate, have to be reactivated by heating. These procedures for application and reactivation are time-consuming and costly and should therefore be avoided.

It is well known that microcellular polyurethane elastomers can be used as a flexible element replacing the rubber. DE-A 195 48 771 and 195 48 770 describe polyurethane elastomers of this type and their use as damping elements.

It is an object of the present invention to develop composite elements which can serve as replacement for known rubber-metal composites, in particular reducing the weight of the composites. In addition, the adhesion between the components of the composite elements should be improved and, in particular, the use, described above, of adhesion promoters avoided.

We have found that this object is achieved by means of the composite elements defined at the outset.

The composite elements may preferably be produced by preparing (ii) in the presence of (i), basing (i) on the reaction of (a) isocyanates with (b) compounds reactive to isocyanates, if desired in the presence of (d) catalysts and/or (e) auxiliaries and/or additives, where the ratio of the isocyanate groups present in (a) to the groups present in (b) and reactive to isocyanates is preferably greater than 1.06:1, particularly preferably from 1.1:1 to 1.2:1.

In the reaction mixture to prepare the TPU (i), isocyanate groups are preferably present in excess over the groups reactive to isocyanate groups. This excess can be expressed in terms of the molar ratio of the isocyanate groups in component (a) to the groups in component (b) which are reactive to isocyanates. As described, this ratio is preferably greater than 1.06:1, particularly preferably from 1.1:1 to 1.2:1.

Due to this excess of isocyanate groups, the free isocyanate groups react with the starting components for the microcellular polyurethane elastomers when these are prepared, in particular with components (b) in the preparation of (ii), giving markedly improved bonding and thus adhesion between (i) and (ii). During and in some cases after the formation of the urethane groups by the reaction of (a) with (b) the free isocyanate groups can also create internal crosslinking in the TPU (i) in the form of, for example, allophanate and/or isocyanurate structures which lead to the improved properties of the TPU. If desired, the creation of the crosslinking may be promoted by adding catalysts, e.g. alkali metal acetates or formates, which are well known for this purpose. The processing of the reaction product, i.e. the TPU, to give films, moldings, injection-molded items, tubing, cable sheathing and/or fibers should preferably take place during and/or directly after the creation of the urethane groups and prior to complete reaction of the reaction mixture, since preference is given to thermoplastic processing of the polyisocyanate polyaddition products to give films, moldings or fibers at low temperatures prior to and/or during the development of crosslinking.

The reaction of the starting components in the process for reparing TPU (i) may take place by known processes, for example the one-shot process or the prepolymer process, for example by reacting an NCO-containing prepolymer prepared from (a) and some of components (b) with the remainder of (b) on a conventional belt system, or using a known reactive extruder or systems known for this purpose. The temperature for this reaction is usually from 60 to 250° C., preferably from 60 to 180° C., particularly preferably from 70 to 120° C. During and, where appropriate, after the creation of the urethane groups by reacting (a) with (b) the reaction products may be pelletized or granulated or processed by well known methods, for example by extrusion in known extruders, by injection molding in conventional injection-molding machines or by well known spinning processes, for example by melt spinning, to give any type of molding or in particular a film.

The reaction mixture for preparing the TPU (i) will preferably be processed in extruders or injection-molding machines to give films or moldings, or by the spinning process to give fibers, during and, in some cases, after the creation of the urethane groups by reacting (a) with (b), particularly preferably from the reaction melt and prior to fully developed formation of allophanate and/or isocyanurate crosslinking. This direct further processing of the reaction mixture without granulation or pelletization and without substantial or complete reaction of the reaction mixture has the advantage that there has been very little or no crosslinking by the creation of, for example, allophanate structures and/or isocyanurate structures, and the reaction mixture can therefore be processed at a desirably low temperature to give the final products, such as films or moldings.

A preferred method of processing the reaction mixture is therefore to process the reaction mixture for preparing the TPU (i) in a softened or melted state during the reaction of (a) with (b), particularly preferably from the reaction melt and prior to fully developed formation of an allophanate and/or isocyanurate crosslinking, at from 60 to 180° C., preferably from 70 to 120° C., in extruders or injection-molding machines, to give films or moldings.

The product of the process, i.e. the TPU from the extruder or injection-molding machine may preferably be annealed at from 20 to 120° C., preferably from 80 to 120° C. for from 2 to 72 hours under the conditions which are otherwise usual. If unsaturated components (b) are used for preparing the TPU, for example cis-1,4-butenediol, the moldings or films may be treated by irradiation, such as electron-beam irradiation, after they have been produced.

According to the invention, the TPUs (i) obtainable in this way are used for producing the composite elements. The TPUs (i) are particularly preferably used in the form of Moldings, usually with a thickness of from 2 to 12 mm.

According to the invention, the composite elements are produced by preparing the microcellular polyurethane elastomers in the presence of (i). Microcellular polyurethane elastomers (ii) and processes for their preparation are well known. They preferably have a density of from 300 to 700 kg/m³, preferably from 350 to 650 kg/m³, a tensile strength to DIN 53571 of from 3 to 8 N/mm², preferably from 3.0 to 7.0 N/mm², an elongation at break to DIN 53571 of from 350 to 550%, preferably from 350 to 400%, a tear propagation resistance to DIN 53515 of from 8 to 30 N/mm, preferably from 8 to 20 N/mm, and a rebound resilience to DIN 53512 of from 50 to 60%, and particularly preferably a cell size of from 50 to 500 μm.

(ii) may be prepared by the well known reaction of (a) isocyanates with (b) compounds reactive to isocyanates, in the presence of (c) blowing agents and, if desired, (d) catalysts and/or auxiliaries and/or additives (e).

(ii) is preferably prepared in the presence of (i) in such a way that the surface of (i) is degreased, for example using conventional, preferably organic, solvents, and then (a) isocyanates are reacted with (b) compounds reactive to isocyanates, in the presence of (c) blowing agents and, if desired, (d) catalysts and/or (e) auxiliaries and/or additives in order to prepare (ii) in the presence of (i).

The amounts of (a) and (b) reacted to prepare (ii) are preferably such as to give a ratio of equivalents of NCO groups in the polyisocyanates (a) to the total of the reactive hydrogen atoms in components (b) of 0.8:1 to 1.2:1.

The microcellular polyurethane elastomers (ii), and therefore the novel composite elements, are advantageously produced by the one-shot process or prepolymer process, for example using the high-pressure or low-pressure technique in open or closed, preferably closed, molds, such as metallic molds, or free-foamed (in-situ foam). The composite elements are preferably produced in molds into which the TPU (i) is preferably placed in the form of a Molding. The reaction of the starting components for preparing (ii) takes place in direct contact with (i), so that the reaction of the starting components produces a bond between (i) and (ii). The internal walls of the molds, in particular those which come into contact with the starting components for preparing (ii), may preferably be provided with a conventional mold-release agent. (ii) is particularly preferably prepared in a closed mold, preferably with a degree of compaction of from 1.1 to 8, particularly preferably from 2 to 6.

The starting components are usually mixed at from 15 to 90° C., preferably from 20 to 60° C. and in particular from 25 to 45° C., and introduced into the open or closed mold. The temperature of the internal surface of the mold is usefully from 20 to 110° C., preferably from 30 to 100° C. and in particular from 70 to 90° C.

In a prepolymer process prepolymers having isocyanate groups are preferably used. The prepolymers preferably have isocyanate contents of from 3 to 5% by weight, based on the total weight. These may be prepared by well known processes, for example by reacting a mixture which comprises an isocyanate (a) and at least one compound (b) reactive to isocyanates, the reaction usually taking place at from 80 to 160° C., preferably from 90 to 150° C. If the prepolymer to be prepared has isocyanate groups an appropriate excess of isocyanate groups over the groups reactive to isocyanate is used in the preparation. The reaction generally ends after from 15 to 200 min.

A preferred method for the process is to prepare (ii) in a closed mold in contact with (i) by reacting a prepolymer having isocyanate groups with a crosslinking agent component comprising (c) blowing agent, (d) catalysts and (e) auxiliaries and/or additives. The crosslinking agent component preferably comprises (c) water, (d) catalyst and, as (e), polysiloxanes, such as polyethermethylsiloxanes, sulfated castor oil or n-alkylbenzenesulfonic acids having from 9 to 15 carbon atoms in the alkyl radical.

Examples of components (a) to (e) will be given below. Unless otherwise stated, the unit of the molar masses given below is g/mol.

a) Well known isocyanates (a) which may be used are in particular organic isocyanates, for example aliphatic, cycloaliphatic, araliphatic and/or aromatic isocyanates, preferably diisocyanates. Individual examples are: hexamethylene 1,6-diisocyanate, 2-methylpentamethylene 1,5-diisocyanate, 2-ethyl-1,4-butylene diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), cyclohexane 1,4-diisocyanate, 1-methylcyclohexane 2,4- and/or -2,6-diisocyanate, dicyclohexylmethane 4,4′-, 2,4′- and/or 2,2′-diisocyanate, 1,4- and/or 1,3-di(isocyanatomethyl)cyclohexane, 1,4- and/or 1,3-di(isocyanatoethyl)cyclohexane, 1,3- and/or 1,4-di(isocyanatomethyl)benzene, tolylene 2,4- and/or 2,6-diisocyanate (TDI), p-phenylene diisocyanate (PDI), p-cyclohexane diisocyanate (CHDI), 3,3′-dimethylbiphenyl 4,4′-diisocyanate (TODI), diphenylmethane 4,4′-, 2,4′- and/or 2,2′-diisocyanate (MDI), mixtures of diphenylmethane 2,4′- and 4,4′-diisocyanate, urethane-modified liquid diphenylmethane 4,4′- and/or 2,4′-diisocyanates, 4,4′-diisocyanato-1,2-diphenylethane and/or naphthylene 1,5-diisocyanate (NDI). Preference is given to the use of hexamethylene 1,6-diisocyanate, IPDI, MDI and/or TDI for preparing the TPU. The microcellular polyurethane elastomers are preferably based on MDI, PDI, CHDI, TODI and/or NDI, particularly preferably MDI and/or NDI.

b) The substances (b) used for preparing the TPU (i) and reactive to isocyanates preferably comprise compounds (b1) which are reactive to isocyanates and have molar masses of from 500 to 8000, preferably those whose average functionality, i.e. functionality averaged over component (b), is from 1.8 to 2.5, preferably from 1.9 to 2.2, particularly preferably from 1.95 to 2.1. Suitable examples are polyhydroxy compounds, preferably polyetherols and polyesterols.

The mixtures for preparing the TPUs and, respectively, the TPUs must be at least predominantly based on difunctional substances reactive to isocyanates.

Other compounds which may be used as substances (b) reactive to isocyanates are polyamines, for example amine-terminated polyethers, e.g. the compounds known as Jeffamine® (Texaco Chemical Co.), and the average functionality of component (b) should lie within the specified range.

Preference is given to the use of polyetherols based on conventional starter substances propylene 1,2-oxide and ethylene oxide, and in which more than 50%, preferably from 60 to 80%, of the OH groups are primary hydroxyl groups and in which at least some of the ethylene oxide has been arranged as a terminal block, and in particular polyoxytetramethylene glycols.

The polyetherols, which in the case of the TPUs are essentially linear, usually have molar masses of from 500 to 8000, preferably from 600 to 6000 and in particular from 800 to 3500. They may be used either individually or as mixtures with one another.

Suitable polyesterols may be prepared, for example, from dicarboxylic acids having from 2 to 12 carbon atoms, preferably from 4 to 8 carbon atoms, preferably adipic acid and/or aromatic dicarboxylic acids, such as phthalic acid, isophthalic acid and/or terephthalic acid, and di- or polyhydric alcohols, such as ethanediol, 1,3-propanediol, 1,4-butanediol, 1,5-pentanediol, 1,6-hexanediol, 1,10-decanediol, 2,2-dimethyl-1,3-propanediol, 1,2-propanediol, diethylene glycol and/or dipropylene glycol.

The polyesterols usually have molar masses of from 500 to 6000, preferably from 800 to 3500.

Component (b) may also comprise other well known chain extenders (b2), which usually have molar masses of less than 500 g/mol, preferably from 60 to 499 g/mol, particularly preferably from 60 to 300 g/mol, in addition to the compounds (b1) mentioned. Examples of these are alkanediols and/or alkenediols and/or alkynediols having from 2 to 12 carbon atoms, preferably having 2, 3, 4 or 6 carbon atoms, for example ethanediol, 1,2-propanediol, 1,3-propanediol, 1,6-hexanediol and in particular 1,4-butanediol and/or cis- and/or trans-1,4-butenediol, and dialkylene ether glycols, for example diethylene glycol and dipropylene glycol. Other suitable compounds are diesters of terephthalic acid with alkanediols having from 2 to 4 carbon atoms, e.g. the bis(ethanediol) or bis(1,4-butanediol) ester of terephthalic acid and hydroxyalkylene ethers of hydroquinone, e.g. 1,4-di(β-hydroxyethyl)hydroquinone. To adjust the hardness and melting point of the TPUs the molar ratios of components (b1) and (b2) may be varied within a relatively wide range. Molar ratios which have proven successful are (b1):(b2)=from 1:1 to 1:12, in particular from 1:1.8 to 1:6.4, where the hardness and melting point of the TPUs rise with increasing (b2) content.

Component (b1) in component (b) for preparing the microcellular polyurethane elastomers (ii) may comprise, in addition to the components (b1) mentioned, well known compounds reactive to isocyanates, for example polyetherols and/or polyesterols with a molar mass of from 500 to 8000 and with functionality of from 1.8 to 5. In addition to the chain extenders previously mentioned as (b2) for (ii) use may be made of well known crosslinking agents (b3) which usually have a functionality of from 3 to 6 and a molar mass of less than 500, preferably from 30 to 400. (b) for preparing (ii) preferably comprises polyesterols with a functionality of from 2 to 3 and a molar mass of from 50 to 8000.

c) Blowing agents (c) which can be used for preparing the microcellular polyurethane elastomers (ii) preferably include water, which reacts with isocyanate groups to form carbon dioxide. The amounts of water usefully used are from 0.1 to 8 parts by weight, preferably from 0.3 to 3.0 parts by weight, in particular from 0.3 to 2.0 parts by weight, based on 100 parts by weight of component (b).

If desired, known physical blowing agents may also be used in a mixture with water. Water is particularly preferably used as sole blowing agent.

d) Suitable catalysts which in particular accelerate the reaction between the NCO groups in the diisocyanates (a) and the hydroxyl groups in structural components (b), are those known from the prior art, for example the conventional tertiary amines, e.g. triethylamine, dimethylcyclohexylamine, N-methylmorpholine, N,N′-dimethylpiperazine, 2-(dimethylaminomethoxy)ethanol, diazabicyclo[2.2.2]octane, and also in particular organometallic compounds, such as titanate esters, iron compounds, e.g. iron(III) acetylacetonate, tin compounds, e.g. tin diacetate, tin dioctoate, tin dilaurate or the dialkyltin salts of aliphatic carboxylic acids, for example dibutyltin diacetate or dibutyltin dilaurate. The amounts usually used of the catalyst (c) are from 0.002 to 0.1 parts per 100 parts of (b).

e) Examples of conventional auxiliaries and/or additives (d) which may be used are surface-active substances, flame retardants, nucleating agents, oxidation inhibitors, stabilizers, lubricants, mold-release agents, dyes and pigments, inhibitors, stabilizers counteracting hydrolysis, reaction of light or heat, or discoloration, inorganic and/or organic fillers, reinforcing agents and plasticizers. Other particular auxiliaries and/or additives for preparing (ii) are those mentioned in lines 6 to 16 on page 8 of DE-A 195 48 771, for example the abovementioned polysiloxanes, such as polyethermethylsiloxanes, sulfated castor oil and n-alkylbenzenesulfonic acids having from 9 to 15 carbon atoms in the alkyl radical.

Further details concerning the abovementioned auxiliaries and additives can be found in the technical literature.

The novel composite elements are preferably used as damping elements in motor vehicle construction, for example in automotive construction as transverse link bearings, rear-axle subframe bearings, stabilizer bearings, longitudinal link bearings, spring-strut support bearings, shock-absorber bearings and/or bearings for triangular links.

The novel composite elements, in particular the damping elements, have not only markedly improved adhesion between the thermoplastic polyurethanes (TPUs) (i) and the microcellular polyurethane elastomers (ii) but also improved mechanical properties of (i), in particular in relation to abrasion and tensile strength.

These advantages will be demonstrated using the examples below.

Preparation of the TPU (i)

The mixes described in Table 1 were reacted in a reactive extruder using the parameters given in Table 2 to give thermoplastic polyurethanes. This TPU was then used to produce test specimens of dimensions 120 mm×30 mm×5 mm. The properties of the TPUs and, respectively, of the test specimens are given in Table 2.

TABLE 1

| | Amount [parts by weight] |
|---|---|
| Component A | |
| Polyol 1 | 51.54 |
| 1,4-Butanediol | 10.93 |
| Elastostab ® H01 | 0.41 |
| Component B | |
| Lupranat ® MET | Proportion given by key number |

Polyol 1: Lupraphen® 9066, commercially available from Elastogran GmbH

Elastostab® H01: hydrolysis stabilizer from Elastogran GmbH

Lupranat® MET: isocyanate commercially available from Elastogran GmbH

TABLE 2

| Example | 1 | 2 | 3 | 4 |
|---|---|---|---|---|
| Key number | 100 | 105 | 110 | 115 |
| Total isocyanate content in TPU, | 0.30 | 0.48 | 0.47 | 0.47 |
| unannealed [%] | | | | |
| Total isocyanate content in TPU, | 0.18 | 0.47 | 0.47 | 0.47 |
| annealed for 30 min at 120° C. [%] | | | | |
| Elongation at break [%] | 490 | 480 | 490 | 480 |
| Tensile strength [N/mm²] | 53 | 55 | 54 | 56 |
| Abrasion ]mm³] | 25 | 30 | 40 | 37 |
| Shore hardness [D] | 55 | 54 | 57 | 57 |
| Density [g/cm³] | 1.21 | 1.21 | 1.215 | 1.215 |

The method of producing the composite elements was to place the cleaned specimens individually into a mold and introduce a reaction mixture into the mold. The microcellular polyurethane was produced in direct contact with the TPU. The mold temperature was 60° C.

The reaction mixture used to prepare the microcellular polyurethanes was a system as set out in Kunststoffhandbuch, Vol. 7, “Polyurethane”, ed. Günter Oertel, 3rd edn., 1993, Carl-Hanser-Verlag, page 428, Example 5.

The composite elements produced had densities of 600 g/cm³. They were then annealed for 16 hours at 110° C., and their properties were tested after a further 5 to 21 days. In particular, the ultimate tensile strength of the composite elements and the nature of their fracture were tested. The advance rate in the tensile test was 20 mm/min. The composite elements consisting of two TPU specimens which had been adhesive-bonded by microcellular polyurethane were clamped into the machine via the TPUs in such a way that they could be subjected to tensile and shear stresses until they fractured. For this the TPU specimens were pulled in opposite directions at the stated advance rate. Table 3 gives the properties of the composite elements.

TABLE 3

| | Ultimate ten- | |
|---|---|---|
| | sile strength | |
| TPU | [N/mm²] | Nature of fracture |
| Example 1 (Key | 1.07 | PU separated from TPU, small |
| number 100) | | residues of PU on the TPU |
| Example 2 (Key | 1.23 | PU separated from TPU, residues |
| number 105) | | of PU on the TPU |
| Example 3 (key | 1.51 | Some separation of PU from TPU, |
| number 110) | | residues of PU on the TPU |
| Example 4 (key | 1.52 | Some separation of PU from TPU, |
| number 115) | | residues of PU on the TPU |

The abbreviation PU in Table 3 indicates the microcellular polyurethanes. As the key number of the TPU rises, the ultimate tensile strength of the composite made from TPU and microcellular polyurethane increases.

The results show that the object has been achieved by means of the novel composite elements. The novel composite elements have markedly improved ultimate tensile strength. In addition, the nature of the fracture indicates that the adhesion between the cellular polyurethanes and the TPU has been significantly improved.

We claim:

1. Composite elements comprising
(i) thermoplastic polyurethanes and, adhering thereto,
(ii) microcellular polyurethane elastomers with a density of from 300 to 700 kg/m³, a tensile strength to DIN 53571 of from 3 to 8 n/mm², an elongation at break to DIN 53571 of from 350 to 550%, a tear propagation resistance to DIN 53515 of from 8 to 30 n/mm and a rebound resilience to DIN 53512 of from 50 to 60%.

2. A process for producing composite elements as claimed in claim 1 by preparing (ii) in the presence of (i), which comprises basing (i) on the reaction of (a) isocyanates with (b) compounds reactive to isocyanates, if desired in the presence of (d) catalysts and/or (e) auxiliaries and/or additives, where the ratio of the isocyanate groups present in (a) to the groups present in (b) and reactive to isocyanates is greater than 1.06:1.

3. A process as claimed in claim 2, wherein the ratio of the isocyanate groups present in (a) to the groups present in (b) and reactive to isocyanates is from 1.1:1 to 1.2:1.

4. A process as claimed in claim 2, wherein (ii) is prepared in a closed mold in contact with (i) by reacting a prepolymer having isocyanate groups with a crosslinking agent component comprising (c) blowing agent, (d) catalysts and (e) auxiliaries and/or additives.

5. A process as claimed in claim 2, wherein the preparation of (ii) is preceded by degreasing that surface of (i) to which (ii) adheres.

6. A process as claimed in claim 4, wherein the crosslinking agent component comprises (c) water, (d) catalyst and, as (e), polysiloxanes, sulfated castor oil or n-alkylbenzenesulfonic acids having from 9 to 15 carbon atoms in the alkyl radical.

7. A composite element obtainable by a process as claimed in any one of claims 2 to 6.

8. The use of composite elements as claimed in claim 1 or 7 as damping elements in automotive construction.

9. A damping element in automotive construction comprising composite elements as claimed in claim 1 or 7.
